(19) United States
(12) Patent Application Publication
(10) Pub. No.: US 2019/0236686 A1
(43) Pub. Date: Aug. 1, 2019

(54) SYSTEMS AND METHODS FOR LOCATING VIRTUAL PRODUCTS AT A PHYSICAL RETAIL STORE

(71) Applicant: Walmart Apollo, LLC, Bentonville, AR (US)

(72) Inventors: John P. Thompson, Bentonville, AR (US); Steven J. Lewis, Bentonville, AR (US); Brian G. McHale, Chadderton Oldham (GB); John J. O'Brien, Farmington, AR (US)

(21) Appl. No.: 16/251,736

(22) Filed: Jan. 18, 2019

Related U.S. Application Data
(60) Provisional application No. 62/622,620, filed on Jan. 26, 2018.

(51) Int. Cl. G06Q 30/06; G06Q 30/02

(52) U.S. Cl. CPC G06Q 30/0639; G06Q 30/0631; G06Q 30/0239; G06Q 30/0643

(57) ABSTRACT

In some embodiments, apparatuses and methods are provided herein useful to locating a virtual retail product. In some embodiments, there is provided a system for locating a virtual product at a store including a product interface configured to store product identifiers, receive initial locations at stores of virtual products, update the initial locations, and update the updated initial locations; one or more sensors configured to detect product identifiers; and a control circuit configured to receive the detected product identifiers, receive a product location query, determine a location of a user in the store, update the second updated initial locations, determine one or more locations corresponding to stored product identifiers, determine a first location of a first product; determine a second location of the retail product, determine whether the first location or the second location is closer to the user; and in response, provide the first location to the product interface.

### CROSS-REFERENCE TO RELATED APPLICATION

This application claims the benefit of U.S. Provisional Application No. 62/622,620 filed Jan. 26, 2018, which is incorporated herein by reference in its entirety.

### TECHNICAL FIELD

This invention relates generally to locating a virtual retail product.

### BACKGROUND

Generally, when a customer is at a retail store to shop for a retail product, the customer may wander down several aisles and/or throughout the retail store in search of the retail product for at least several minutes before the customer finds the retail product. This may be a little less or more if the customer knows the general location of the retail store's sales floor inventory. However, this experience could certainly turn to worse if the customer has no general knowledge of the retail store's sales floor layout or if the retail store had modified the general location of the retail store's sales floor inventory. In either scenario, the customer's time has been wasted in searching for the retail product.

### BRIEF DESCRIPTION OF THE DRAWINGS

Disclosed herein are embodiments of systems, apparatuses and methods pertaining to locating a virtual retail product at a physical retail store. This description includes drawings, wherein:

FIG. 1 illustrates a simplified block diagram of an exemplary system for locating a virtual retail product at a physical retail store in accordance with some embodiments;

FIG. 2 shows a flow diagram of an exemplary process of locating a virtual retail product at a physical retail store in accordance with some embodiments;

FIG. 3 shows a continuation of the flow diagram of the method 200 in FIG. 2 for locating a virtual retail product at a physical retail store in accordance with some embodiments;

FIG. 4 shows a continuation of the flow diagram of the method 200 in FIG. 2 for locating a virtual retail product at a physical retail store in accordance with some embodiments;

FIG. 5 shows a flow diagram of an exemplary process of locating a virtual retail product at a physical retail store in accordance with some embodiments;

FIG. 6 shows a flow diagram of an exemplary process of locating a virtual retail product at a physical retail store in accordance with some embodiments;

FIG. 7 shows a flow diagram of an exemplary process of locating a virtual retail product at a physical retail store in accordance with some embodiments;

FIG. 8 shows a flow diagram of an exemplary process of locating a virtual retail product at a physical retail store in accordance with some embodiments; and

FIG. 9 illustrates an exemplary system for use in implementing methods, techniques, devices, apparatuses, systems, servers, sources and locating a virtual retail product at a physical retail store, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for locating a virtual retail product at a physical retail store. In some embodiments, a system for locating a virtual retail product at a physical retail store includes a product interface. By one approach, the product interface may be associated with a retail store and operable on a user electronic device. By another approach, the product interface may receive one or more selections of one or more virtual products by a user associated with the user electronic device. By another approach, the product interface may store one or more retail product identifiers based on the one or more selections by the user. In one configuration, the product interface may receive initial locations at a plurality of retail stores of the one or more virtual products based on the receipt of the one or more selections. In another configuration, the product interface may update, at a first time, the initial locations when the user is within a first threshold distance from at least one of the plurality of retail stores. In another configuration, the product interface may update, at a second time, the updated initial locations when the user is within a second threshold distance from the at least one of the plurality of retail stores. By another approach, the system may include one or more sensors. In one example, the one or more sensors may detect the one or more retail product identifiers associated with one or more retail products that are physically located at a retail store the plurality of retail stores when the one or more retail products are within a threshold of sensing distance of the one or more sensors. By another approach, the system may include the control circuit. In one configuration, the control circuit may communicatively couple to the one or more sensors and the product interface. In another configuration, the control circuit may receive the detected one or more retail product identifiers. In another configuration, the control circuit may receive a product location query from the product interface. In one example, the product location query may be based on the stored one or more retail product identifiers. By one approach, the control circuit may determine a location of the user in the retail store based on geofence data associated with the user electronic device. By another approach, the control circuit may update, at a third time, the second updated initial locations associated with the retail store in response to the determination of the location of the user in the retail store. By another approach, the control circuit may determine one or more locations of the one or more retail products corresponding to the stored one or more retail product identifiers throughout the retail store based on at least one of the detected one or more retail product identifiers and the third updated initial locations. By another approach, the control circuit may determine a first location of a first retail product of the one or more retail products based on the one or more locations. By another approach, the control circuit may determine a second location of the first retail product based on the one or more locations. By another approach, the control circuit may determine whether the first location or the second location is closer to the location of the user in the retail store. By yet another approach, the control circuit may, in response to the determination that the first location is closer to the location of the user in the retail store, provide the first location to the product interface. In one example, the product interface may show on a display device of the user electronic device the first location of the first retail product to enable the user to locate the first retail product that is closest to the user when the user is at the retail store.

In some embodiments, a method for locating a virtual retail product at a physical retail store includes receiving, at a product interface, initial locations at a plurality of retail stores of one or more virtual products based on one or more selections of the one or more virtual products by a user associated with a user electronic device. By one approach, the method may include updating, at a first time by the product interface, the initial locations when a user is within a first threshold distance from at least one of the plurality of retail stores. By another approach, the method may include updating, at a second time by the product interface, the updated initial locations when the user is within a second threshold distance from the at least one of the plurality of retail stores. By another approach, the method may include receiving, at a control circuit, one or more retail product identifiers detected by one or more sensors dispersed throughout a retail store. In one configuration, the method may include receiving, at the control circuit, a product location query from the product interface associated with a retail store of the plurality of retail stores and operable on a user electronic device of a user. In one example, the product location query may be based on the one or more retail product identifiers stored by the product interface. In another example, the one or more retail product identifiers stored by the product interface may be based on one or more selections of one or more virtual products by the user via the product interface. In another configuration, the method may include determining, by the control circuit, a location of the user in the retail store based on geofence data associated with the user electronic device. In another configuration, the method may include updating, at a third time by the control circuit, the second updated initial locations associated with the retail store in response to the determining of the location of the user in the retail store. In another configuration, the method may include determining, by the control circuit, one or more locations of one or more retail products throughout the retail store based on at least one of the one or more retail product identifiers detected by the one or more sensors and the third updated initial locations. By one approach, the method may include determining, by the control circuit, a first location of a first retail product of the one or more retail products based on the one or more locations. By another approach, the method may include determining a second location of the first retail product based on the one or more locations. By yet another approach, the method may include determining, by the control circuit, whether the first location or the second location is closer to the location of the user in the retail store. Yet in one configuration, the method may include, in response to the determination that the first location is closer to the location of the user in the retail store, providing, by the control circuit, the first location to the product interface. In one example, the product interface may show on a display device of the user electronic device the first location of the first retail product to enable the user to locate the first retail product that is closest to the user when the user is at the retail store.

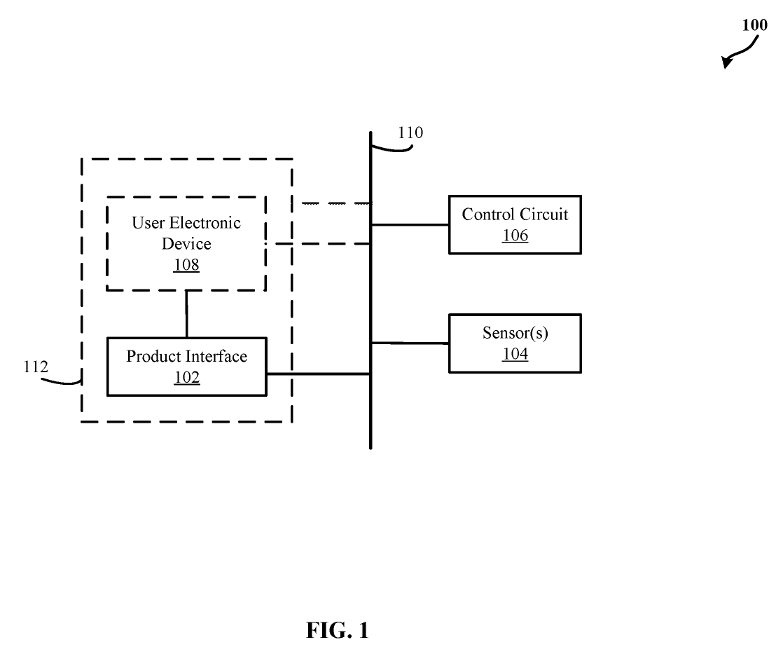

FIG. 1 illustrates a simplified block diagram of an exemplary system 100 for locating a virtual retail product at a physical retail store in accordance with some embodiments. The system 100 includes a product interface 102. By one approach, the product interface 102 may be operable on a user electronic device 108. By another approach, the product interface 102 may be integrated 112 with the user electronic device 108. In one configuration, the product interface 102 may correspond to an electronic device configured to couple communicatively and/or physically, and operate in cooperation with the user electronic device 108. In another configuration, the product interface 102 may correspond to a computer program product embodied on a computer readable storage medium, for example, a local memory of the user electronic device 108. In one example, the computer readable storage medium may comprise a read only memory (ROM), an electrically erasable programmable read-only memory (EEPROM), a random-access memory (RAM), a hard disk drive, a secure digital card, a non-volatile memory device, a volatile memory device, and/or other memory devices and data storage devices configured to store electronic data and/or digital data. In one configuration, the system 100 may include the user electronic device 108. In one example, the user electronic device 108 may comprise a laptop, a smartphone, an iPad, a tablet, a smartwatch, a wearable glasses, and/or any electronic device that may be carriable by a user from one place to another and/or carriable on the user's person. In another configuration, the system 100 may include a control circuit 106. In one example, the control circuit 106 may be implemented by multiple different processing systems and/or servers distributed over one or more computer and/or communication network (e.g., Wide Area Network, Local Area Network, internet, other such networks, or a combination of two or more of such networks). In another example, the control circuit 106 may be implemented with and/or by a sub-control circuit at each of the retail stores that cooperatively communicate and collectively operate.

By one approach, the control circuit 106 may be communicatively coupled to the product interface 102 and/or user electronic device 108 via a communication network 110. In one example, the communication network 110 may include a cellular network, a local area network, a WiFi network, a blockchain network, an internet network, and/or any network that is capable of bridging communication between electronic devices to another one or more electronic device. In another configuration, the system 100 may include one or more sensors 104 that are communicatively coupled to the control circuit 106, the product interface 102 and/or user electronic device 108 via the communication network 110. In one example, the one or more sensors 104 may include cameras, optical based scanning sensors to sense and read optical patterns (e.g., bar codes), radio frequency identification (RFID) tag reader sensors capable of reading RFID tags in proximity to the sensor, and other such sensors, and/or the like. The foregoing examples are intended to be illustrative and are not intended to convey an exhaustive listing of all possible sensors. Instead, it will be understood that these teachings will accommodate various sensing devices that are capable of and/or may be used in conjunction with another devices that enable the control circuit 106 to track retail products throughout one or more retail stores and determine the retail products' whereabouts at any given time based on sensor data output by these various sensing devices. As such, for example, the sensors 104 may detect the retail product identifiers associated with the retail products that are physically located at a retail store of a plurality of retail stores when the retail products are within a threshold of sensing distance of the sensors 104.

As an illustrative non-limiting example, the system 100 locates actual physical products, each corresponding to virtual retail products, at one or more physical retail stores. Each of the virtual retail products may correspond to a retail product identifier identifying a particular actual retail product at the retail stores. As virtual products are selected by the customer, the product interface 102 is configured to obtain a corresponding product identifier of actual products at actual stores for each of the selected products, and stores those product identifiers. In one example, each of the retail stores may have a varying amount of inventory for the particular retail product. In one scenario, retail store A may have 10 items available for the particular retail product in its inventory while retail store B may have 0 item available for the particular retail product in its corresponding inventory. In another scenario, in the retail store A, 7 items of the particular retail product may be found at a first location in the retail store where the particular retail product is usually stocked and shelved, for example, on a third shelf from the bottom by aisle 7. However, the remaining 3 items in the inventory for the particular retail product may be found in three separate locations throughout the retail store A, for example, by a magazine shelf of cashier 8, by a top shelf at aisle 1, and by a dairy shelf of a grocery section of the retail store A. As such, based on sensor data output by the sensors 104, the control circuit 106 may determine various locations of inventory items of a plurality of retail products throughout one or more retail stores. By one approach, a first location and/or a second location provided to the product interface 102 by the control circuit 106 may correspond to particular locations in the retail store that are not a store assigned location to find the particular retail product (i.e., these products are misplaced by customers or workers and not in their intended location).

In one configuration, the product interface 102 may communicate with the control circuit 106 to determine one or more locations of actual items corresponding to each of the one or more virtual products selected by a user through the user electronic device 108 at a retail store. By one approach, the product interface 102 may determine the locations of the one or more actual items of the virtual products at each of multiple relevant retail stores based on stored one or more retail product identifiers corresponding to the one or more virtual products. For example, the retail stores considered relevant by the product interface 102 may be retail stores that are within a threshold distance of the user's current location and/or expected locations (e.g., based on historic stores, historic travel, expected destination of the user if the user is currently travelling, etc.). By another approach, the product interface 102 may initially receive initial locations of actual products corresponding to the virtual products at a plurality of retail stores and corresponding to the retail product identifiers when the user made the selection of the virtual products. For example, the initial locations may indicate locations of the actual products at the plurality of retail stores at a first time the user selected the virtual products. In one scenario, the product interface 102 may, at the first time, perform a full download of data including the locations of the actual products at the plurality of retail stores and the corresponding retail product identifiers. In another scenario, at a second time, the product interface 102 may perform an incremental update to the data reflecting the current locations of the actual products at the second time. As such, an initial receipt of a location of an actual product at a retail store and a corresponding retail product identifier corresponds to a full download of data to a memory associated with the product interface 102. As such, a subsequent update of the location may correspond to an incremental update to the data stored in the memory.

Alternatively or in addition to, the receipt of the locations may be triggered by an input from the user. In another configuration, the initial locations of the virtual products may be updated when the user is within a first threshold distance from at least one of the plurality of retail stores providing updated initial locations. For example, the retail store A and a retail store D are within a first threshold distance from the user when the user is at a first location at a first time (e.g., a gas station three blocks from the user's house). In such an example, the initial locations of the product identifiers corresponding to the selected virtual products stored in the product interface 102 may be updated to reflect the current locations of the actual items of the virtual products at the plurality of retail stores at the first time. By one approach, the initial locations of the virtual products may only be updated to reflect the current locations of the virtual products at the retail store A and the retail store D, instead of updating the previously stored locations of the virtual products at the other retail stores. By another approach, the product interface 102 may determine that a new retail store Q is within the first threshold distance from the user. As such, the product interface 102 may receive locations of the actual products corresponding to the virtual products at the new retail store Q. In another configuration, the product interface 102 may again update, at a second time, the updated initial locations when the user is within a second threshold distance from the at least one of the plurality of retail stores and/or a newly determined retail store (e.g., the retail store Q) providing second updated initial locations. For example, the user may be a block away from the retail store D. As such, the updated initial locations may be updated for a second time providing the second updated initial locations. By one approach, a second update to the updated initial locations may be for current locations of the virtual products at the plurality of retail stores at the second time. By another approach, the second update may only update the current locations of the virtual products at the retail store D based on the user being within the second threshold. In another example, the product interface 102 may determine a current location of the user electronic device 108 (e.g. based on location data (e.g., global positioning satellite (GPS) data, triangulation data, movement sensor data, etc.) provided by the user electronic device 108). In such an example, based on the current location, the product interface 102 may identify one or more retail stores within a threshold distance (or a travel threshold distance) of the current location of the user electronic device 108. By one approach, the travel threshold distance may vary based on one or more factors (e.g., current location, whether the user is currently moving, previous retail stores visited by the user, historic travel routes of the user, etc.). In one configuration, as the user continues to move, the retail stores that are within the travel threshold distance may vary over time. As such, the initial location information the actual products corresponding to the selected virtual products may be updated to include location information of actual items at a different store. In one example, while updating the initial location information, the product interface 102 may remove location information no longer within the travel threshold distance. In another example, the product interface 102 may wait until the user is at and/or within a predetermined distance from a retail store before removing location information no longer within the travel threshold distance of the user.

Further, the control circuit 106 receives the detected retail product identifiers based on sensor data provided the sensors 104. By one approach, the control circuit 106 may receive a product location query from the product interface 102. In one example, the product location query may be based on the stored one or more retail product identifiers corresponding to the selected virtual products. In another example, the receipt of the product location query may be based on the product interface 102 determining that the user is at a retail store, for example, the retail store D. In another example, the receipt of the product location query may be based on an input from the user through the product interface 102 (e.g., the user selecting a product, the user selecting a displayed option to “locate products”, and or other such triggers). By another approach, the control circuit 106 may determine a location of the user in the retail store based on geofence data associated with the user electronic device 108. For example, in cooperation with the product interface 102, the control circuit 106, and/or the user electronic device 108, the geofence data including one or more predefined virtual geographic boundaries associated with the retail store may trigger the user electronic device 108 to provide to the control circuit 106 a current location of the user while the user is at the retail store. In one scenario, the geofence data may be defined by the sensors 104 (e.g., GPS and/or RFID technology, or the like).

By another approach, the control circuit 106 may update, at a third time, the second updated initial locations associated with the retail store in response to the determination of the location of the user in the retail store. For example, in response to the product location query from the product interface 102 and the determination by the product interface 102 that the user is at the retail store, the updated initial locations stored in the product interface 102 may updated for a third time by the control circuit 106 providing third updated initial locations so that the locations of the retail product identifiers corresponding to the virtual products selected by the user indicate the current locations of the retail product identifiers at the third time. In one example, the control circuit 106 may update the locations at the plurality of retail stores. In another example, the control circuit 106 may only update the locations at the retail store in which the user is currently located, for example, the retail store D. In one configuration, the control circuit 106 may update the current locations of the retail product identifiers based on locations of the retail product identifiers as recently stored by a database communicatively coupled to the control circuit 106. In another configuration, the control circuit 106 may update the current locations of the retail product identifiers based on the retail product identifiers detected by the sensors 104. The sensor data may have previously been obtained, or obtained at a time the control circuit 106 initiates a detection of the retail product identifiers by the sensors 104. In another configuration, the updated initial locations for the third time by the control circuit 106 and the detected retail product identifiers by the sensors 104 (e.g., the most recent databased stored locations of the retail product identifiers and/or an initiated detection by the sensors 104, as previously described) may differ by a threshold of time lag. For example, the detected retail product identifiers by the sensors 104 may correspond to locations of the retail product identifiers at time 12:05 PM whereas the updated initial locations for the third time may correspond to locations of the retail product identifiers at time 12:07 PM. As such, the control circuit 106 may determine one or more locations of the one or more retail products corresponding to the stored one or more retail product identifiers throughout the retail store based on the detected one or more retail product identifiers and/or the third updated initial locations. By one approach, the control circuit 106 may select the most recent locations of the retail product identifiers at the store. In another example, the control circuit 106 may initiate association of the retail product identifiers with the retail products, location of where in the retail store the sensors 104 read the retail product identifiers, and/or a time the sensors 104 read the retail product identifiers. By another approach, the control circuit 106 may trigger the database to store the association. In some embodiments, the product interface 102 may delete location data associated with the stored locations of the retail products that are associated with retail stores not currently being visited by the user based on the geofence data associated with the user electronic device 108. For example, the product interface 102 may determine that that the user is at one retail store and not at the other retail store based on the geofence data. In one example, the product interface 102 may delete the location data associated with the stored locations of the retail products associated with retail stores not currently being visited by the user when the control circuit 106 determines a location of the user in the retail store the user is currently visiting. In another example, the location data associated with the retail stores not being visited by the user may be deleted by the product interface 102 as the user gets closer to the retail store that the user is finally at. As such, one or more memory devices associated with the product interface 102 and storing location data corresponding to the locations of the virtual products selected by user are periodically updated and/or purged based on the deletion of the location data as described herein.

In one configuration, the system simplifies the user's shopping experience by directing the user to selected products that are closest to the user and/or that are located along a shopping route through a particular retail store in which the user is located. The control circuit 106 may determine a first location within the particular retail store of a first item of a first retail product of the one or more retail products based on the determined one or more locations of the retail products throughout the retail store. By one approach, the control circuit 106 may determine a second location within the particular retail store of a second item of the same first retail product based on the determined one or more locations of the retail products. By another approach, the control circuit 106 may determine whether the first location or the second location is closer to the current location of the user in the retail store. For example, the control circuit 106 may determine that items of a first retail product of the retail products selected by the user is located at four locations throughout the retail store D. In one scenario, the locations, starting from closest to farthest from an entrance of the retail store D, are a magazine shelf by cashier 8, a top shelf at aisle 1, a third shelf from the bottom by aisle 7, and a dairy shelf of a grocery section of the retail store D. By one approach, the control circuit 106 may determine that the magazine shelf by cashier 8 is the closest location of the first retail product to the user at that time, which, for example, may be at the entrance of the retail store D. Alternatively or in addition to, the control circuit 106 may, in response to the determination that the first location is closer to the location of the user in the retail store, provide the first location to the product interface 102. For example, the control circuit 106 may communicate to the product interface 102 that the location of the first retail product that is closest to the user is the magazine shelf by cashier 8. Alternatively or in addition to, the product interface 102 may show (and/or the control circuit 106 may cause the product interface 102 to show) on a display device of the user electronic device 108 a first location of the first retail product (e.g., a virtual representation of the magazine shelf by cashier 8 on a virtual map (e.g., a planogram, a retail store floor plan, a layout of the retail store, and a map of the retail store, among other types of diagrammatic representations of a retail store) of the retail store D and/or a listing of locations including the magazine shelf by cashier 8, among other ways to show locations on the display device) to enable the user to locate the first retail product that is closest to the user when the user is at the retail store. Alternatively or in addition to, the product interface 102 may provide an audible direction to the first location of the first retail product through the user electronic device 108. Alternatively or in addition to, the control circuit 106 may provide the second location (e.g., the top shelf at aisle 1) to the product interface 102. In one example, the product interface 102 may show on the display device the second location of the first retail product to show the user a next closest location of the first retail product to the user. In the illustrative non-limiting examples described herein, the first and second locations are locations that are not the usual location where the first retail product is normally stocked and/or placed by an associate of the retail store. Instead, the usual location may be the third next closest location to the user, for example, the third shelf from the bottom by aisle 7. In one example, the product interface 102 may show on the display device the first location and the second location on a planogram received when locations of the first retail product was initially received. For example, when a user enters a virtual reality (VR) medium associated with the product interface 102, the VR medium may define a nearest and/or preferred retail store to the user's current physical location. In response, the product interface 102 may receive and/or load the planogram of nearest and/or preferred retail store to facilitate locating actual products corresponding to virtual retail products at the retail store, and thereby, providing the user a comfortable shopping experience.

In another configuration, the control circuit 106 may determine which one of the retail products corresponding to the product identifiers stored in the product interface 102 is shown on the display device based on an amount of discount associated with each of the retail products, most frequently bought retail product of the retail products, and/or a retail product of the retail products the user has not bought for a while. By one approach, the control circuit 106 may determine whether a first retail product or a second retail product of the retail products corresponding to the product identifiers stored in the product interface 102 is a retail product that offers a greater discount. Alternatively or in addition to, the control circuit 106 may, in response to the determination that the second retail product is the retail product that offers the greater discount, cause the product interface 102 to display a third location of the second retail product based on the determined locations by providing to the product interface 102 the third location of the second retail product to enable the user to locate the retail product that offers the greater discount. In one example, the third location may correspond to a location of the second retail product that is closest to the user. In another example, the product interface 102 may show on a display device the closest location of one or more retail products associated with the selected virtual products stored in the product interface 102 as the user moves across the retail store.

In another configuration, the control circuit 106 may determine whether a first retail product or a second retail product of the retail products is a retail product most frequently bought by the user. By one approach, the control circuit 106 may, in response to the determination that the second retail product is the retail product most frequently bought by the user, provide to the product interface a third location of the second retail product based on the locations. For example, the third location may correspond to a location of the second retail product that is closest to the user. In another example, the product interface 102 may show on a display device the third location of the second retail product to enable the user to locate the retail product most frequently bought by the user. In another configuration, the control circuit 106 may determine whether a first retail product or a second retail product of the retail products is a retail product that the user has not bought within a threshold of time. By one approach, the control circuit 106 may, in response to the determination that the second retail product is the retail product that the user has not bought within the threshold of time, provide to the product interface a third location of the second retail product based on the locations. For example, the third location may correspond to a location of the second retail product that is closest to the user. In another example, the product interface 102 may show on the display device the third location of the second retail product to enable the user to locate the retail product that the user has not bought within the threshold of time.

In another configuration, the product interface 102 may store additional one or more retail product identifiers based on one or more retail products automatically recommended by the control circuit 106 to the user. For example, in response to the determination of a location of the user in the retail store, the control circuit 106 may recommend to the user one or more retail products in accordance with the user's prior purchases, the user's preferences, frequency of the user's purchase of one or more particular retail products, and/or a threshold of time difference between a first purchase and a second purchase of the one or more particular retail products. In another example, the product interface 102 may store recommended retail products and/or show on the display device one or more closest locations of one or more of the recommended retail products.

In some embodiments, the control circuit 106 may receive a notification that the user bought the first retail product. By one approach, the control circuit 106 may, in response to the notification, make available to the user a virtual representation of the first retail product to enable the user to customize the virtual representation of the first retail product. For example, the control circuit 106 may cause the product interface 102 to display a link for the user to click on to download a virtual representation of a retail product the user bought at the retail user. In another example, the user may receive an email message including the link. By one approach, the virtual representation may include a computer program product that when downloaded by the user the computer program product is embodied on a computer readable storage medium, for example, a memory associated with the user electronic device 108 and/or the product interface 102. In such an approach, the user may modify, via the product interface 102, the virtual representation of the retail product by customizing features of the retail product. For example, the user bought a red, size medium polo shirt. In such an example, through the product interface 102, the user may customize the virtual representation of the red, size medium polo shirt by modifying the length of the sleeves of the polo shirt and/or the torso length of the polo shirt, for example. By one approach, the product interface 102 may access the stored virtual representation of the first retail product when the user starts customizing the virtual representation. By another approach, the product interface 102 may receive one or more modifications to the virtual representation of the first retail product based on user customized changes to the virtual representation. In one example, at the initiation of the user and/or at the completion of the customization of the virtual representation of the first retail product, the product interface 102 may provide a retail order associated with the user to the control circuit 106. In one configuration, the retail order may include a purchase order for a modified first retail product. In such a configuration, the modified first retail product may be based, in part, on the modified and/or customized virtual representation of the first retail product. As such, when a manufacture of a customized retail product that corresponds to the modified and/or customized virtual representation of the first retail product is available, the control circuit 106 may send the customized retail product to a delivery destination associated with the purchase order.

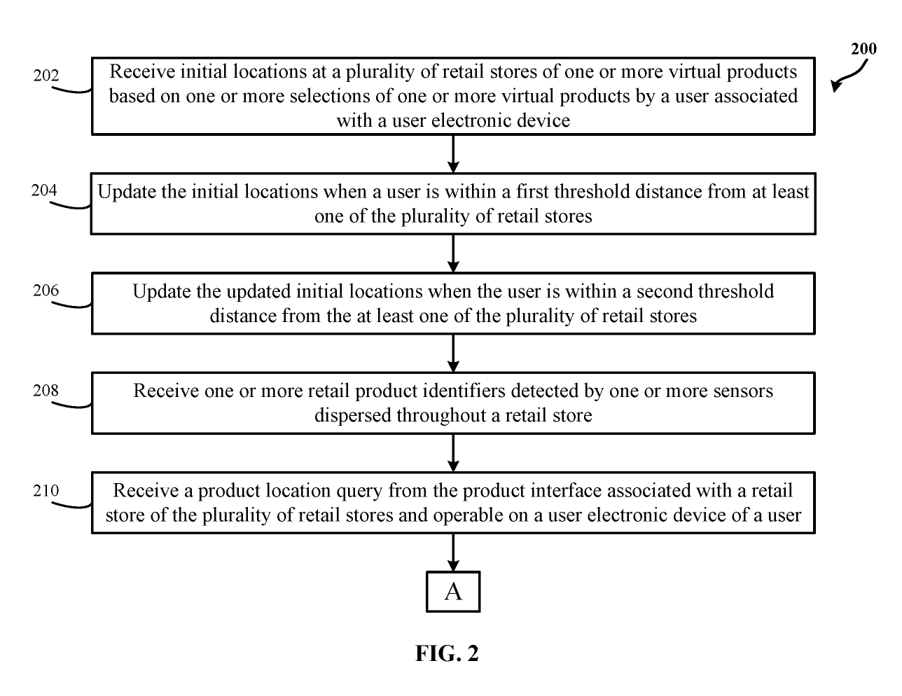

FIG. 2 illustrates a flow diagram of an exemplary method 200 for locating a virtual retail product at a physical retail store. By one approach, the exemplary method 200 may be implemented in the system 100 of FIG. 1. By another approach, one or more steps in the method 200 may be implemented in the product interface 102, the control circuit 106, and/or the user electronic device 108 of FIG. 1. The method 200 includes, at step 202, receiving initial locations at a plurality of retail stores of one or more virtual products based on one or more selections of the one or more virtual products by a user associated with a user electronic device. In one configuration, the method 200 may include, at step 204, updating, at a first time, the initial locations when a user is within a first threshold distance from at least one of the plurality of retail stores. In another configuration, the method 200 may include, at step 206, updating, at a second time, the updated initial locations when the user is within a second threshold distance from the at least one of the plurality of retail stores. In another configuration, the method 200 may include, at step 208, receiving one or more retail product identifiers detected by one or more sensors dispersed throughout a retail store. In another configuration, the method 200 may include, at step 210, receiving a product location query from the product interface associated with a retail store of the plurality of retail stores and operable on a user electronic device of a user. In one example, the product location query may be based on the one or more retail product identifiers stored by the product interface. In another example, the one or more retail product identifiers stored by the product interface may be based on one or more selections of one or more virtual products by the user via the product interface.

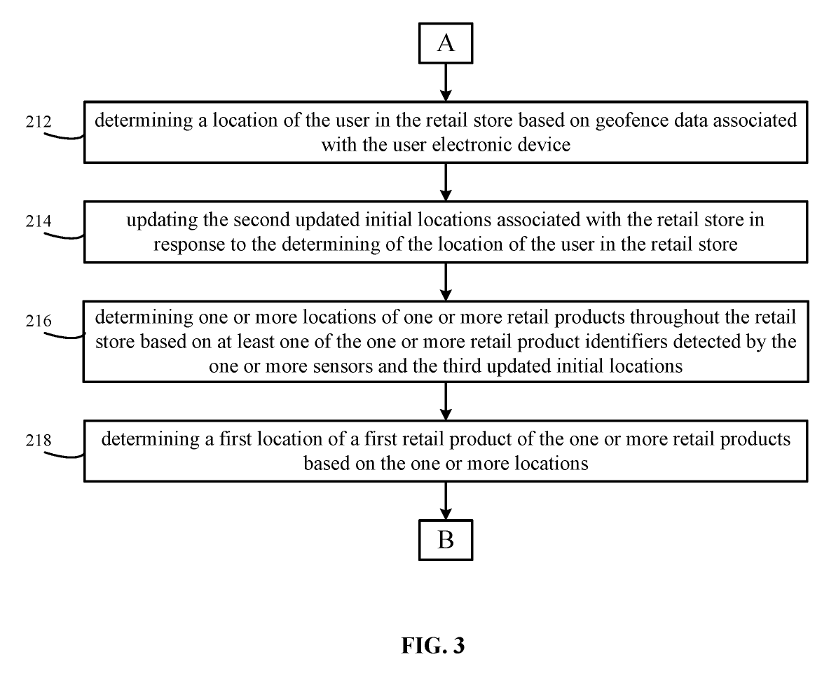

FIG. 3 illustrates a continuation of the flow diagram of the method 200 for locating a virtual retail product at a physical retail store. By one approach, the method 200 may include, at step 212, determining a location of the user in the retail store based on geofence data associated with the user electronic device. By another approach, the method 200 may include, at step 214, updating, at a third time, the second updated initial locations associated with the retail store in response to the determining of the location of the user in the retail store. By another approach, the method 200 may include, at step 216, determining one or more locations of one or more retail products throughout the retail store based on at least one of the one or more retail product identifiers detected by the one or more sensors and the third updated initial locations. By yet another approach, the method 200 may include determining a first location of a first retail product of the one or more retail products based on the one or more locations, at step 218.

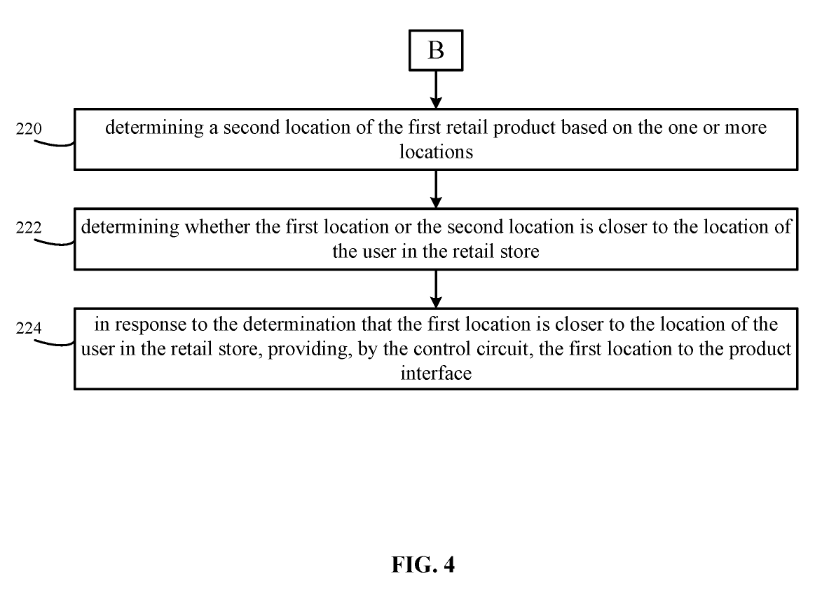

FIG. 4 illustrates a continuation of the flow diagram of the method 200 for locating a virtual retail product at a physical retail store. By one approach, the method 200 may include, at step 220, determining a second location of the first retail product based on the one or more locations. By another approach, the method 200 may include, at step 222, determining whether the first location or the second location is closer to the location of the user in the retail store. By yet another approach, the method 200 may include, in response to the determination that the first location is closer to the location of the user in the retail store, providing the first location to the product interface, at step 224. In one example, the product interface may show on a display device of the user electronic device the first location of the first retail product to enable the user to locate the first retail product that is closest to the user when the user is at the retail store.

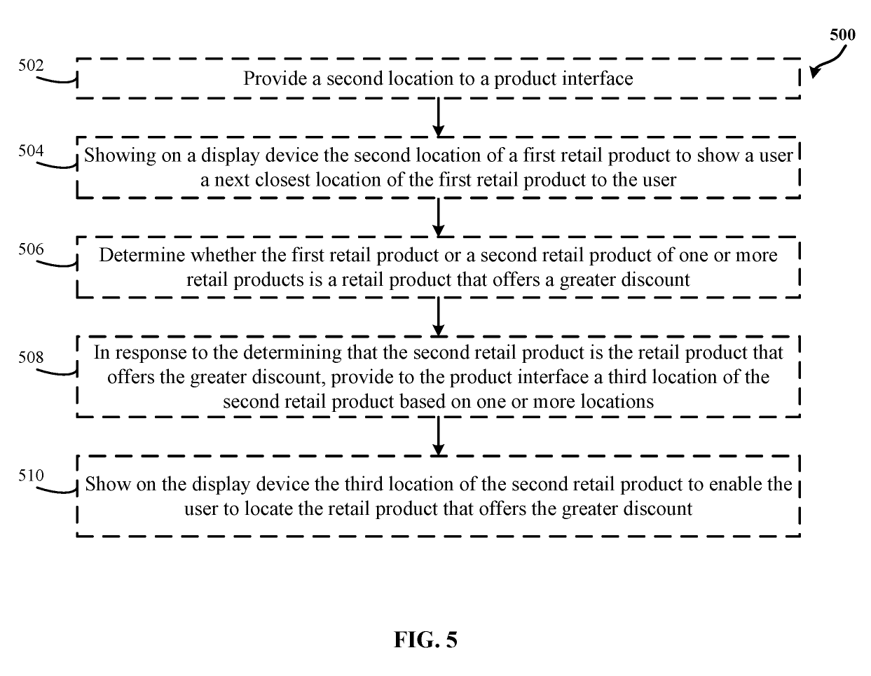

FIG. 5 shows a flow diagram of an exemplary method 500 for locating a virtual retail product at a physical retail store in accordance with some embodiments. The method 500 may be implemented in the system 100 of FIG. 1. By another approach, one or more steps in the method 500 may be implemented in the product interface 102, the control circuit 106, and/or the user electronic device 108 of FIG. 1. By another approach, the method 500 and/or one or more steps of the method may optionally be included in and/or performed in cooperation with the method 200 of FIGS. 2-4. In one configuration, the method 500 may include, at step 502, providing a second location to a product interface. By one approach, the method 500 may include, at step 504, showing on the display device the second location of a first retail product to show a user a next closest location of the first retail product to the user. By another approach, the method 500 may include, at step 506, determining whether the first retail product or a second retail product of the one or more retail products is a retail product that offers a greater discount. By another approach, the method 500 may include, at step 508, in response to the determining that the second retail product is the retail product that offers the greater discount, providing to the product interface a third location of a second retail product based on one or more locations. In one example, the third location may be a location of the second retail product that is closest to the user. By another approach, the method 500 may include, at step 510, showing on a display device the third location of the second retail product to enable the user to locate a retail product that offers a greater discount.

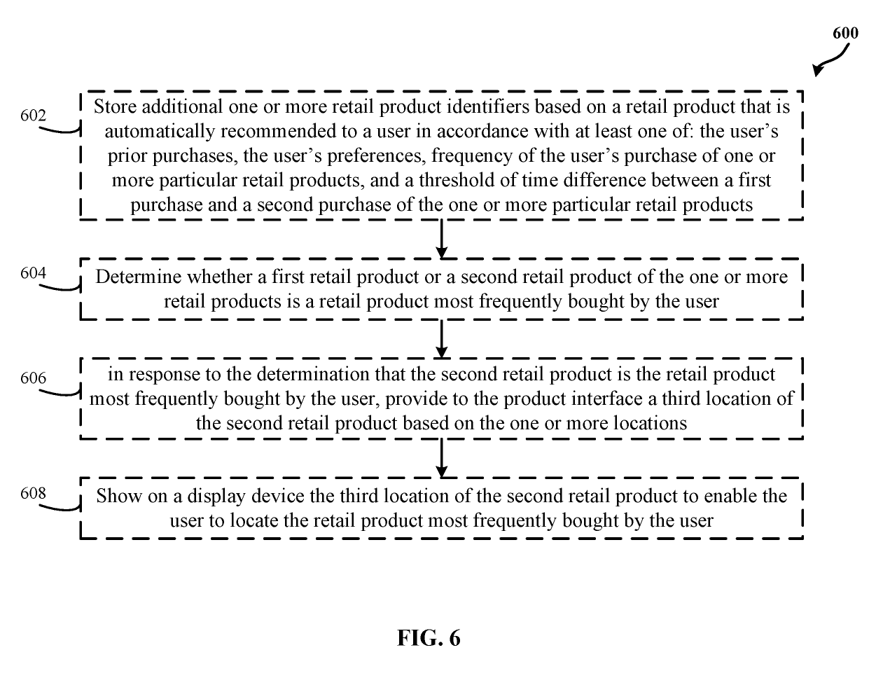

FIG. 6 shows a flow diagram of an exemplary method 600 for locating a virtual retail product at a physical retail store in accordance with some embodiments. The method 600 may be implemented in the system 100 of FIG. 1. By another approach, one or more steps in the method 600 may be implemented in the product interface 102, the control circuit 106, and/or the user electronic device 108 of FIG. 1. By another approach, the method 600 and/or one or more steps of the method may optionally be included in and/or performed in cooperation with the method 200 of FIGS. 2-4 and/or the method 500 of FIG. 5. In one configuration, the method 600 may include, at step 602, storing additional one or more retail product identifiers based on a retail product that is automatically recommended to a user in accordance with at least one of: the user's prior purchases, the user's preferences, frequency of the user's purchase of one or more particular retail products, and a threshold of time difference between a first purchase and a second purchase of the one or more particular retail products. In another configuration, the method 600 may include, at step 604, determining whether the first retail product or a second retail product of the one or more retail products is a retail product most frequently bought by the user. In another configuration, the method 600 may include, at step 606, in response to the determining that the second retail product is the retail product most frequently bought by the user, providing to the product interface a third location of the second retail product based on the one or more locations. In one example, the third location may be a location of the second retail product that is closest to the user. In yet another configuration, the method 600 may include, at step 608, showing on a display device the third location of the second retail product to enable the user to locate a retail product most frequently bought by the user.

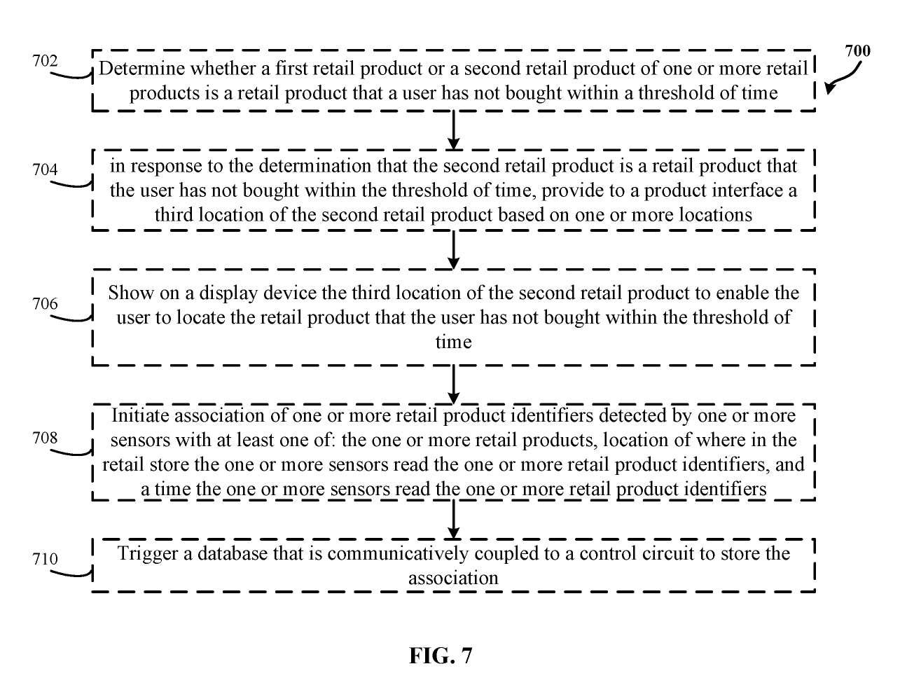

FIG. 7 shows a flow diagram of an exemplary method 700 for locating a virtual retail product at a physical retail store in accordance with some embodiments. The method 700 may be implemented in the system 100 of FIG. 1. By another approach, one or more steps in the method 700 may be implemented in the product interface 102, the control circuit 106, and/or the user electronic device 108 of FIG. 1. By another approach, the method 700 and/or one or more steps of the method may optionally be included in and/or performed in cooperation with the method 200 of FIGS. 2-4, the method 500 of FIG. 5, and/or the method 600 of FIG. 6. In one configuration, the method 700 may include, at step 702, determining whether a first retail product or a second retail product of one or more retail products is a retail product that a user has not bought within a threshold of time. In another configuration, the method 700 may include, at step 704, providing to the product interface a third location of the second retail product based on the one or more locations in response to the determination that the second retail product is the retail product that the user has not bought within the threshold of time. In one example, the third location may be a location of the second retail product that is closest to the user. In another configuration, the method 700 may include, at step 706, showing on a display device the third location of the second retail product to enable a user to locate a retail product that the user has not bought within the threshold of time. In another configuration, the method 700 may include, at step 708, initiating association of one or more retail product identifiers detected by one or more sensors with at least one of: one or more retail products, location of where in the retail store the one or more sensors read the one or more retail product identifiers, and a time the one or more sensors read the one or more retail product identifiers. In another configuration, the method 700 may include triggering a database that is communicatively coupled to a control circuit to store the association, at step 710.

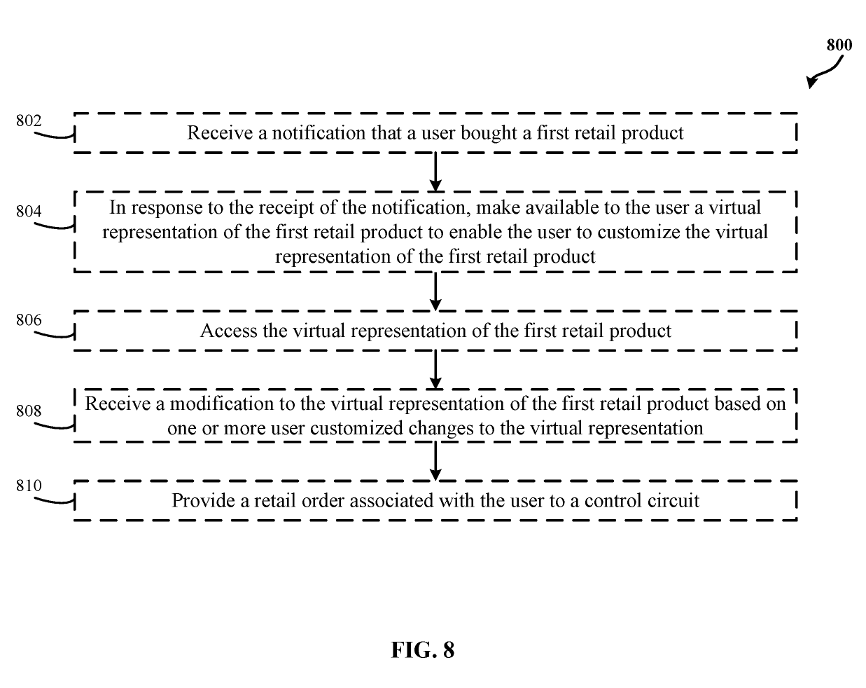

FIG. 8 shows a flow diagram of an exemplary method 800 for locating a virtual retail product at a physical retail store in accordance with some embodiments. The method 800 may be implemented in the system 100 of FIG. 1. By another approach, one or more steps in the method 800 may be implemented in the product interface 102, the control circuit 106, and/or the user electronic device 108 of FIG. 1. By another approach, the method 800 and/or one or more steps of the method may optionally be included in and/or performed in cooperation with the method 200 of FIGS. 2-4, the method 500 of FIG. 5, the method 600 of FIG. 6, and/or the method 700 of FIG. 7. In one configuration, the method 800 may include, at step 802, receiving a notification that a user bought a first retail product. In another configuration, the method 800 may include, at step 804, making available to the user a virtual representation of the first retail product to enable the user to customize the virtual representation of the first retail product in response to the receipt of the notification. In another configuration, the method 800 may include, at step 806, accessing the virtual representation of the first retail product. In another configuration, the method 800 may include, at step 808, receiving a modification to the virtual representation of the first retail product based on one or more user customized changes to the virtual representation. In yet another configuration, the method 800 may include providing a retail order associated with the user to a control circuit. In one example, the retail order may include a purchase order of a modified first retail product. In another example, the modified first retail product may be based on at least the modified virtual representation of the first retail product.

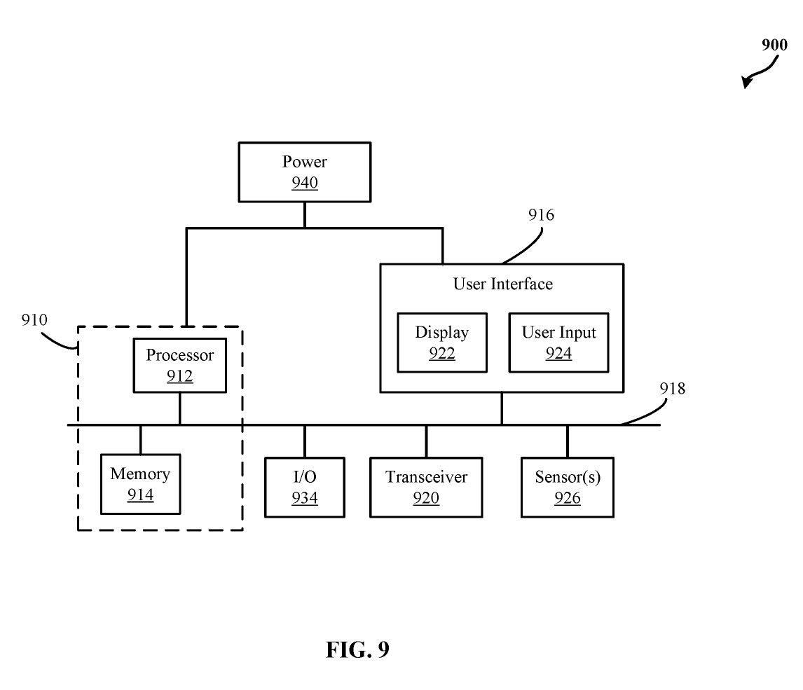

Further, the circuits, circuitry, systems, devices, processes, methods, techniques, functionality, services, servers, sources and the like described herein may be utilized, implemented and/or run on many different types of devices and/or systems. FIG. 9 illustrates an exemplary system 900 that may be used for implementing any of the components, circuits, circuitry, systems, functionality, apparatuses, processes, or devices of the system 100 of FIG. 1, the method 200 of FIGS. 2-4, the method 500 of FIG. 5, the method 600 of FIG. 6, the method 700 of FIG. 7, the method 800 of FIG. 8, and/or other above or below mentioned systems or devices, or parts of such circuits, circuitry, functionality, systems, apparatuses, processes, or devices. For example, the system 900 may be used to implement some or all of the system 100 for locating a virtual retail product at a physical retail store, the product interface 102, the control circuit 106, the one or more sensors 104, the user electronic device 108, and/or other such components, circuitry, functionality and/or devices. However, the use of the system 900 or any portion thereof is certainly not required.

By way of example, the system 900 may comprise a processor module (or a control circuit) 912, memory 914, and one or more communication links, paths, buses or the like 918. Some embodiments may include one or more user interfaces 916, and/or one or more internal and/or external power sources or supplies 940. The control circuit 912 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 912 can be part of control circuitry and/or a control system 910, which may be implemented through one or more processors with access to one or more memory 914 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 500 may be used to implement one or more of the above or below, or parts of, components, circuits, systems, processes and the like. For example, the system 900 may implement the system 100 for locating a virtual retail product at a physical retail store with the control circuit 106 and/or the product interface 102 being the control circuit 912.

The user interface 916 can allow a user to interact with the system 900 and receive information through the system. In some instances, the user interface 916 includes a display 922 and/or one or more user inputs 924, such as buttons, touch screen, track ball, keyboard, mouse, etc., which can be part of or wired or wirelessly coupled with the system 900. Typically, the system 900 further includes one or more communication interfaces, ports, transceivers 920 and the like allowing the system 900 to communicate over a communication bus, a distributed computer and/or communication network (e.g., a local area network (LAN), the Internet, wide area network (WAN), etc.), communication link 918, other networks or communication channels with other devices and/or other such communications or combination of two or more of such communication methods. Further the transceiver 920 can be configured for wired, wireless, optical, fiber optical cable, satellite, or other such communication configurations or combinations of two or more of such communications. Some embodiments include one or more input/output (I/O) interface 934 that allow one or more devices to couple with the system 900. The I/O interface can be substantially any relevant port or combinations of ports, such as but not limited to USB, Ethernet, or other such ports. The I/O interface 934 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 926 to provide information to the system and/or sensor information that is communicated to another component, such as the user electronic device 108, the product interface 102, the control circuit 106, the one or more sensor 104, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 900 comprises an example of a control and/or processor-based system with the control circuit 912. Again, the control circuit 912 can be implemented through one or more processors, controllers, central processing units, logic, software and the like. Further, in some implementations the control circuit 912 may provide multiprocessor functionality.

The memory 914, which can be accessed by the control circuit 912, typically includes one or more processor readable and/or computer readable media accessed by at least the control circuit 912, and can include volatile and/or nonvolatile media, such as RAM, ROM, EEPROM, flash memory and/or other memory technology. Further, the memory 914 is shown as internal to the control system 910; however, the memory 914 can be internal, external or a combination of internal and external memory. Similarly, some or all of the memory 914 can be internal, external or a combination of internal and external memory of the control circuit 912. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 914 can store code, software, executables, scripts, data, content, lists, programming, programs, log or history data, user information, customer information, product information, and the like. While FIG. 9 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for locating a virtual retail product at a physical retail store comprising:
a product interface associated with a retail store of the plurality of retail stores and operable on a user electronic device, the product interface configured to:
receive one or more selections of one or more virtual products by a user associated with the user electronic device;
store one or more retail product identifiers based on the one or more selections by the user;
receive initial locations of the one or more virtual products at the plurality of retail stores based on the receipt of the one or more selections;
update, at a first time, the initial locations when the user is within a first threshold distance from at least one of the plurality of retail stores; and
update, at a second time, the updated initial locations when the user is within a second threshold distance from the at least one of the plurality of retail stores;
one or more sensors within each of the plurality of retail stores configured to:
detect the one or more retail product identifiers associated with one or more retail products that are physically located at the retail store when the one or more retail products are within a threshold sensing distance of the one or more sensors; and
a control circuit communicatively coupled to the one or more sensors and the product interface, the control circuit configured to:
receive the detected one or more retail product identifiers;
receive a product location query from the product interface, wherein the product location query is based on the stored one or more retail product identifiers;
determine a location of the user in the retail store based on geofence data associated with the user electronic device;
update, at a third time, the second updated initial locations associated with the retail store in response to the determination of the location of the user in the retail store;
determine one or more locations of the one or more retail products corresponding to the stored one or more retail product identifiers throughout the retail store based on at least one of the detected one or more retail product identifiers and the third updated initial locations;
determine a first location of a first retail product of the one or more retail products based on the one or more locations;
determine a second location of the first retail product based on the one or more locations;
determine whether the first location or the second location is closer to the location of the user in the retail store; and
in response to the determination that the first location is closer to the location of the user in the retail store, provide the first location to the product interface, wherein the product interface is further configured to show on a display device of the user electronic device the first location of the first retail product to enable the user to locate the first retail product that is closest to the user when the user is at the retail store.

2. The system of claim 1, wherein the control circuit is further configured to provide the second location to the product interface, and wherein the product interface is further configured to show on the display device the second location of the first retail product to show the user a next closest location of the first retail product to the user.

3. The system of claim 1, wherein the control circuit is further configured to:
determine whether the first retail product or a second retail product of the one or more retail products is a retail product that offers a greater discount; and
in response to the determination that the second retail product is the retail product that offers the greater discount, cause the product interface to display a third location of the second retail product based on the one or more locations by providing to the product interface the third location of the second retail product to enable the user to locate the retail product that offers the greater discount, wherein the third location is a location of the second retail product that is closest to the user.

4. The system of claim 1, wherein, in storing the stored one or more retail product identifiers, the product interface is further configured to store additional one or more retail product identifiers based on a retail product that is automatically recommended by the control circuit to the user in accordance with at least one of: the user's prior purchases, the user's preferences, frequency of the user's purchase of one or more particular retail products, and a threshold of time difference between a first purchase and a second purchase of the one or more particular retail products.

5. The system of claim 1, wherein the control circuit is further configured to:
determine whether the first retail product or a second retail product of the one or more retail products is a retail product most frequently bought by the user; and
in response to the determination that the second retail product is the retail product most frequently bought by the user, provide to the product interface a third location of the second retail product based on the one or more locations, wherein the third location is a location of the second retail product that is closest to the user, and wherein the product interface is further configured to show on the display device the third location of the second retail product to enable the user to locate the retail product most frequently bought by the user.

6. The system of claim 1, wherein the control circuit is further configured to:
determine whether the first retail product or a second retail product of the one or more retail products is a retail product that the user has not bought within a threshold of time; and
in response to the determination that the second retail product is the retail product that the user has not bought within the threshold of time, provide to the product interface a third location of the second retail product based on the one or more locations, wherein the third location is a location of the second retail product that is closest to the user, and wherein the product interface is further configured to show on the display device the third location of the second retail product to enable the user to locate the retail product that the user has not bought within the threshold of time.

7. The system of claim 1, wherein, in the detection of the detected one or more retail product identifiers, the one or more sensors is further configured to read the one or more retail product identifiers associated with the one or more retail products at the retail store whenever the one or more retail product identifiers are within the threshold sensing distance of the one or more sensors, and wherein the control circuit is further configured to:
initiate association of the one or more retail product identifiers with at least one of: the one or more retail products, location of where in the retail store the one or more sensors read the one or more retail product identifiers, and a time the one or more sensors read the one or more retail product identifiers; and
trigger a database that is communicatively coupled to the control circuit to store the association.

8. The system of claim 1, wherein the control circuit is further configured to:
receive a notification that the user bought the first retail product; and
in response to the notification that the user bought the first retail product, make available to the user a virtual representation of the first retail product to enable the user to customize the virtual representation of the first retail product.

9. The system of claim 8, wherein the product interface is further configured to:
access the virtual representation of the first retail product;
receive a modification to the virtual representation of the first retail product based on one or more user customized changes to the virtual representation; and
provide a retail order associated with the user to the control circuit, wherein the retail order comprises a purchase order of a modified first retail product, and wherein the modified first retail product is based on at least the modified virtual representation of the first retail product.

10. The system of claim 1, wherein at least one of the first location and the second location corresponds to a particular location in the retail store that is not a store assigned location to find the first retail product.

11. The system of claim 1, wherein the first retail product is associated with a plurality of items having the same retail product identifiers of the detected one or more retail product identifiers in inventory, wherein a first item of the plurality of items of the first retail product is at the first location, and wherein a second item of the plurality of items of the first retail product is at the second location.

12. A method for locating a virtual retail product at a physical retail store comprising:
receiving, at a product interface, initial locations of one or more virtual products at a plurality of retail stores based on one or more selections of the one or more virtual products by a user associated with a user electronic device;
updating, at a first time by the product interface, the initial locations when a user is within a first threshold distance from at least one of the plurality of retail stores; and
updating, at a second time by the product interface, the updated initial locations when the user is within a second threshold distance from the at least one of the plurality of retail stores;
receiving, at a control circuit, one or more retail product identifiers detected by one or more sensors dispersed throughout a retail store of the plurality of retail stores;
receiving, at the control circuit, a product location query from the product interface associated with the retail store and operable on a user electronic device of a user, wherein the product location query is based on the one or more retail product identifiers stored by the product interface, and wherein the one or more retail product identifiers stored by the product interface is based on the one or more selections of the one or more virtual products by the user via the product interface;
determining, by the control circuit, a location of the user in the retail store based on geofence data associated with the user electronic device;
updating, at a third time by the control circuit, the second updated initial locations associated with the retail store in response to the determining of the location of the user in the retail store;
determining, by the control circuit, one or more locations of one or more retail products throughout the retail store based on at least one of the one or more retail product identifiers detected by the one or more sensors and the third updated initial locations;
determining, by the control circuit, a first location of a first retail product of the one or more retail products based on the one or more locations;
determining a second location of the first retail product based on the one or more locations;
determining, by the control circuit, whether the first location or the second location is closer to the location of the user in the retail store; and
in response to the determination that the first location is closer to the location of the user in the retail store, providing, by the control circuit, the first location to the product interface, wherein the product interface is configured to show on a display device of the user electronic device the first location of the first retail product to enable the user to locate the first retail product that is closest to the user when the user is at the retail store.

13. The method of claim 12, further comprising:
providing, by the control circuit, the second location to the product interface; and
showing, by the product interface, on the display device the second location of the first retail product to show the user a next closest location of the first retail product to the user.

14. The method of claim 12, further comprising:
determining, by the control circuit, whether the first retail product or a second retail product of the one or more retail products is a retail product that offers a greater discount; and
in response to the determining that the second retail product is the retail product that offers the greater discount, providing, by the control circuit, to the product interface a third location of the second retail product based on the one or more locations, wherein the third location is a location of the second retail product that is closest to the user; and
showing, by the product interface, on the display device the third location of the second retail product to enable the user to locate the retail product that offers the greater discount.

15. The method of claim 12, further comprising storing, by the product interface, additional one or more retail product identifiers based on a retail product that is automatically recommended to the user in accordance with at least one of: the user's prior purchases, the user's preferences, frequency of the user's purchase of one or more particular retail products, and a threshold of time difference between a first purchase and a second purchase of the one or more particular retail products.

16. The method of claim 12, further comprising:
determining, by the control circuit, whether the first retail product or a second retail product of the one or more retail products is a retail product most frequently bought by the user; and
in response to the determining that the second retail product is the retail product most frequently bought by the user, providing, by the control circuit, to the product interface a third location of the second retail product based on the one or more locations, wherein the third location is a location of the second retail product that is closest to the user; and
showing, by the product interface, on the display device the third location of the second retail product to enable the user to locate the retail product most frequently bought by the user.

17. The method of claim 12, further comprising:
determining, by the control circuit, whether the first retail product or a second retail product of the one or more retail products is a retail product that the user has not bought within a threshold of time; and
in response to the determining that the second retail product is the retail product that the user has not bought within the threshold of time, providing, by the control circuit, to the product interface a third location of the second retail product based on the one or more locations, wherein the third location is a location of the second retail product that is closest to the user; and
showing, by the product interface, on the display device the third location of the second retail product to enable the user to locate the retail product that the user has not bought within the threshold of time.

18. The method of claim 12, further comprising:
initiating association of the one or more retail product identifiers detected by the one or more sensors with at least one of: the one or more retail products, location of where in the retail store the one or more sensors read the one or more retail product identifiers, and a time the one or more sensors read the one or more retail product identifiers; and
triggering a database that is communicatively coupled to the control circuit to store the association.

19. The method of claim 12, further comprising:
receiving a notification that the user bought the first retail product; and
in response to the receiving of the notification, making available to the user a virtual representation of the first retail product to enable the user to customize the virtual representation of the first retail product.

20. The method of claim 19, further comprising:
accessing, by the product interface, the virtual representation of the first retail product;
receiving, by the product interface, a modification to the virtual representation of the first retail product based on one or more user customized changes to the virtual representation; and
providing, by the product interface, a retail order associated with the user to the control circuit, wherein the retail order comprises a purchase order of a modified first retail product, and wherein the modified first retail product is based on at least the modified virtual representation of the first retail product.

21. The method of claim 12, further comprising, at the product interface:
receiving a plurality of virtual maps associated with the plurality of retail stores in response to the receiving of the initial locations; and
showing on the display device the first location of the first retail product via at least one of: a listing of the first location and a diagrammatic indication of the first location on a virtual map of the plurality of virtual maps, wherein the virtual map comprises a retail store floor plan, a planogram, a layout of the retail store, and a map of the retail store.
